(19) United States
(12) Patent Application Publication
(10) Pub. No.: US 2026/0051594 A1
(43) Pub. Date: Feb. 19, 2026

(54) POWER STORAGE DEVICE

(71) Applicant: TOYOTA JIDOSHA KABUSHIKI KAISHA, Toyota-shi (JP)

(72) Inventors: Masataka Ogushi, Nisshin-shi (JP); Yutaroh Gotoh, Toyota-shi (JP); Masato Moritaka, Chiryu-shi (JP); Hiroaki Sueyoshi, Okazaki-shi (JP)

(73) Assignee: TOYOTA JIDOSHA KABUSHIKI KAISHA, Toyota-shi (JP)

(21) Appl. No.: 19/251,902

(22) Filed: Jun. 27, 2025

(30) Foreign Application Priority Data
Aug. 19, 2024 (JP) 2024-137890

(51) Int. Cl. H01M 50/242; B60L 50/60; B60L 50/64; H01M 50/209; H01M 50/249; H01M 50/289

(52) U.S. Cl. CPC H01M 50/242; B60L 50/64; B60L 50/66; H01M 50/209; H01M 50/249; H01M 50/289; H01M 2220/20

(57) ABSTRACT

A power storage device, includes: a first battery stack group in which plural first battery stacks, are stacked in an up-down direction; a second battery stack group in which plural second battery stacks, are stacked in the up-down direction, the second battery stack group being arranged at a lower side of the first battery stack group with a longitudinal direction of the second battery stack group being a direction that intersects with a longitudinal direction of the first battery stack group; and a first frame member that is arranged between the first battery stack group and the second battery stack group, the first battery stack group and the second battery stack group being respectively fixed to the first frame member, and the first frame member being directly or indirectly fixed to a vehicle skeleton.

### CROSS-REFERENCE TO RELATED APPLICATION

This application is based on and claims priority under 35 USC 119 from Japanese Patent Application No. 2024-137890, filed on Aug. 19, 2024, the entire disclosure of which is incorporated by reference herein.

### BACKGROUND

### Technical Field

The present disclosure relates to a power storage device.

### Related Art

Japanese Patent Application Laid-Open (JP-A) No. 2013-134809 discloses technology relating to a battery pack (hereinafter, referred to as a power storage device) which holds a battery module (hereinafter, referred to as a battery stack) in which plural battery cells are housed. In this prior art, plural battery stacks are stacked in an up-down direction, whereby the capacity of the battery can be increased.

However, in the above-described prior art, since the same battery stacks are stacked in the up-down direction, there are concerns regarding vibration resistance.

### SUMMARY

The present disclosure provides a power storage device capable of improving vibration resistance.

A power storage device according to a first aspect includes: a first battery stack group in which plural first battery stacks, each having a substantially rectangular parallelepiped shape forming a substantially rectangular shape in plan view, are stacked in an up-down direction; a second battery stack group in which plural second battery stacks, each having a substantially rectangular parallelepiped shape forming a substantially rectangular shape in plan view, are stacked in the up-down direction, the second battery stack group being arranged at a lower side of the first battery stack group with a longitudinal direction of the second battery stack group being a direction that intersects with a longitudinal direction of the first battery stack group; and a first frame member that is arranged between the first battery stack group and the second battery stack group, the first battery stack group and the second battery stack group being respectively fixed to the first frame member, and the first frame member being directly or indirectly fixed to a vehicle skeleton.

In the power storage device according to the first aspect, a first battery stack group, a second battery stack group, and a first frame member are provided. In the first battery stack group, plural first battery stacks, each having a substantially rectangular parallelepiped shape which forms a substantially rectangular shape in plan view, are stacked in the up-down direction, and in the second battery stack group, plural second battery stacks, each having a substantially rectangular parallelepiped shape which forms a substantially rectangular shape in plan view, are stacked in the up-down direction. Further, the second battery stack group is arranged at the lower side of the first battery stack group with a longitudinal direction of the second battery stack group being a direction that intersects with a longitudinal direction of the first battery stack group. Furthermore, the first frame member is arranged between the first battery stack group and the second battery stack group, the first battery stack group and the second battery stack group are respectively fixed to the first frame member, and the first frame member is directly or indirectly fixed to a vehicle skeleton.

For example, as a comparative example, in a case in which battery stacks, each having a substantially rectangular parallelepiped shape forming a substantially rectangular shape in plan view, are stacked in the up-down direction with the longitudinal direction being the same, vibration resistance becomes weak with respect to a width direction of the battery stacks (a lateral direction that is orthogonal to the longitudinal direction). For this reason, in the comparative example, there are concerns regarding the vibration resistance with respect to a vibration G in a specific direction.

In this regard, in the present aspect, by the first frame member, to which the first battery stack group and the second battery stack group are respectively fixed in a state in which the longitudinal directions thereof intersect with each other, being directly or indirectly fixed to the vehicle skeleton, it is possible to change the direction in which vibration resistance becomes weak between the first battery stack group and the second battery stack group, and to achieve balance between the direction in which vibration resistance is strong and the direction in which vibration resistance is weak, whereby the direction in which vibration resistance is weak can be offset. As a result, in the present aspect, vibration resistance of the power storage device can be improved, and the influence of resonance can be suppressed.

It should be noted that the meaning of “intersect” here includes being substantially orthogonal in addition to being completely orthogonal. Further, “directly or indirectly fixed” means a configuration in which the first frame member is indirectly fixed to the vehicle skeleton via a bracket or the like in addition to a configuration in which the first frame member is directly fixed to the vehicle skeleton. Furthermore, examples of the “vehicle skeleton” include a vehicle skeleton such as a cross member that extends in the vehicle width direction from a portion at which the power storage device is arranged, and a side member that extends in the vehicle front-rear direction.

A power storage device according to a second aspect is the power storage device according to the first aspect, wherein: in each of the plural first battery stacks, plural first battery cells are stacked in a longitudinal direction of the plural first battery stacks; and in each of the plural second battery stacks, plural second battery cells are stacked in a longitudinal direction of the plural second battery stacks.

In the power storage device according to the second aspect, in each of the plural first battery stacks, plural first battery cells are stacked in the longitudinal direction of the plural first battery stacks, and in each of the plural second battery stacks, plural second battery cells are stacked in the longitudinal direction of the plural second battery stacks. In other words, a direction along the stacking direction of the first battery cells is the longitudinal direction of the first battery stacks, and a direction along the stacking direction of the second battery cells is the longitudinal direction of the second battery stacks.

In general, in a case in which battery cells are stacked along a width direction that is orthogonal to a longitudinal direction of a battery stack, that is, in a case in which the longitudinal direction of the battery stack and the longitudinal direction of the battery cells are the same, a substantially central portion of the battery stack in the longitudinal direction becomes easily bent. In the present aspect, since the first battery cells and the second battery cells are stacked along the longitudinal direction of the first battery stacks and the longitudinal direction of the second battery stacks, respectively, bending of a substantially central portion of the first battery stacks and the second battery stacks in the longitudinal direction can be suppressed.

It should be noted that, as the first battery cells and the second battery cells, battery cells having the same configuration may be used, or battery cells having different configurations may be used.

A power storage device according to a third aspect is the power storage device according to the first aspect or the second aspect, wherein: an upper-layer battery stack group, which is configured by the first battery stack group, is arranged in a vehicle width direction; a lower-layer battery stack group, which is configured by the second battery stack group, is arranged in a the vehicle width direction; and plural second battery stack groups are arranged in a row such that a projection dimension of the lower-layer battery stack group is larger than a projection dimension of the upper-layer battery stack group.

In the power storage device according to the third aspect, the upper-layer battery stack group that is configured by the first battery stack group is arranged along the vehicle width direction. Further, the lower-layer battery stack group that is configured by the second battery stack group is arranged along the vehicle width direction. Furthermore, in the lower-layer battery stack group, plural second battery stack groups are arranged in a row such that the projection dimension of the lower-layer battery stack group is larger than the projection dimension of the upper-layer battery stack group.

As a result, since the projection dimension of the lower-layer battery stack group is larger than the projection dimension of the upper-layer battery stack group, the center of gravity of the power storage device can be brought toward a lower-layer battery stack side, whereby the vibration stability of the power storage device can be improved.

A power storage device according to a fourth aspect is the power storage device according to any one of the first aspect to the third aspect, further including: a housing case that houses the upper-layer battery stack group and the lower-layer battery stack group; a lower case that configures a bottom wall portion of the housing case; and a second frame member that is fixed to the lower case and that is arranged between the plural second battery stack groups, with each of the plural of second battery stack groups being fixed to the second frame member.

In the power storage device according to the fourth aspect, a housing case that houses the upper-layer battery stack group and the lower-layer battery stack group is provided. A second frame member is fixed to a lower case that configures a bottom wall portion of the housing case. The second frame member is arranged between the plural second battery stack groups, and the respective second battery stack groups are fixed to the second frame member.

In the present aspect, since the plural second battery stack groups configuring the lower-layer battery stack group are respectively fixed to the second frame member, which is fixed to the lower case, the vibration stability of the power storage device can be further improved.

As described above, in the power storage device according to the present disclosure, vibration resistance can be improved.

### BRIEF DESCRIPTION OF THE DRAWINGS

Exemplary embodiments of the present disclosure will be described in detail based on the following figures, wherein:

FIG. 1 is a schematic perspective view that illustrates a power storage device according to the present embodiment;

FIG. 2 is a schematic diagram that schematically illustrates the power storage device illustrated in FIG. 1;

FIG. 3A is a front view that schematically illustrates the power storage device illustrated in FIG. 1;

FIG. 3B is a side view that schematically illustrates the power storage device illustrated in FIG. 1; and

FIG. 4 is a schematic diagram that illustrates a comparative example.

### DETAILED DESCRIPTION

Explanation follows regarding a power storage device according to an exemplary embodiment of the present disclosure, with reference to the drawings. It should be noted that the arrow UP, the arrow L, and the arrow W, which are shown in each of the drawings as appropriate, respectively indicate an upward direction, a longitudinal direction, and a width direction of a battery stack (first battery stack) 12 and a battery stack (second battery stack) 14 which configure a power storage device 10 according to the present exemplary embodiment. Further, a vehicle to which the power storage device according to the present exemplary embodiment is applied is an electric vehicle.

First, explanation follows regarding the configuration of the power storage device according to the present exemplary embodiment.

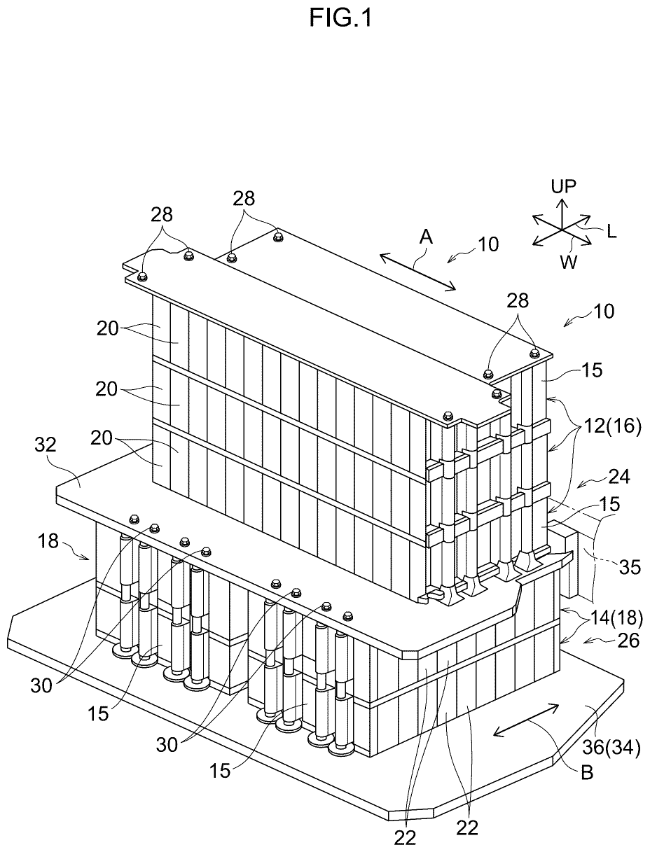

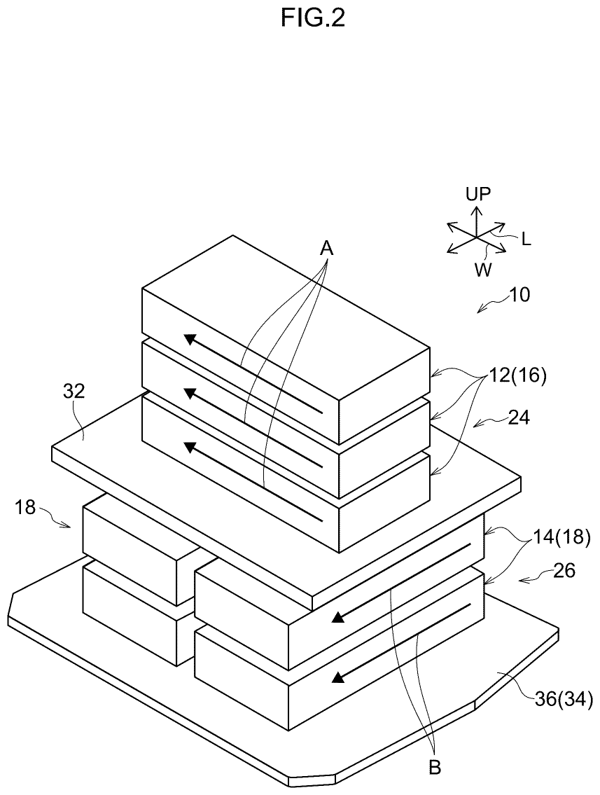

As illustrated in FIG. 1 and FIG. 2, the power storage device 10 includes plural battery stacks 12 and plural battery stacks 14, and is disposed, for example, at a vehicle rear side. It should be noted that FIG. 2 is a schematic diagram that schematically illustrates the power storage device 10 illustrated in FIG. 1. As illustrated in FIG. 1 and FIG. 2, the battery stacks 12 and 14 each have a substantially rectangular parallelepiped shape, each battery stack 12 includes plural battery cells (first battery cells) 20, and each battery stack 14 includes plural battery cells (second battery cells) 22.

The battery cells 20 and 22 can be selected from secondary batteries such as lithium-ion secondary batteries (including liquid-based batteries and all-solid-state batteries), lead storage batteries, nickel-metal hydride batteries, nickel-cadmium storage batteries, nickel-iron storage batteries, nickel-zinc storage batteries, silver oxide-zinc storage batteries, and cobalt-titanium lithium secondary batteries.

Further, the battery cells 20 and 22 respectively have a flat rectangular parallelepiped shape and are respectively stacked along a longitudinal direction of the battery stacks 12 and 14. In other words, in the battery stacks 12 and 14, the direction along a stacking direction of the battery cells 20 and 22 is the longitudinal direction of the battery stacks 12 and 14. Furthermore, plate-shaped end plates 15, which have high rigidity, are respectively provided at each longitudinal direction end portion of the battery stacks 12 and 14. It should be noted that the battery cells 20 and the battery cells 22 may have the same configuration or may have different configurations. For example, the outer dimensions of the battery cells 20 and the battery cells 22 may be different.

In the present exemplary embodiment, the power storage device 10 includes an upper-layer battery stack group 24 that is arranged at an upper side of the power storage device 10, and a lower-layer battery stack group 26 that is arranged at a lower side of the power storage device 10, both of which are stacked in an up-down direction.

The upper-layer battery stack group 24 is configured by stacking plural (in this case, three) battery stacks 12 in the up-down direction. Further, each battery stack 12 is arranged so that the stacking direction of the battery cells 20 (the direction of the arrow A) is the vehicle width direction (the direction of the arrow W). Furthermore, the battery stacks 12 that are adjacent to each other in the up-down direction are fixed to each other by, for example, holes (not illustrated in the drawings), which are formed in the end plates 15 respectively provided at each longitudinal end portion of the battery stacks 12, and through bolts 28.

As a result, the plural battery stacks 12, which are stacked in the up-down direction, are referred to as a battery stack group (first battery stack group) 16. In other words, in the present exemplary embodiment, the upper-layer battery stack group 24 is configured by the battery stack group 16.

On the other hand, in the lower-layer battery stack group 26, plural (in this case, two) battery stacks 14 are stacked in the up-down direction. Each battery stack 14 is arranged so that the stacking direction of the battery cells 22 (the direction of the arrow B) is a vehicle front-rear direction (the direction of arrow L). Further, in the same manner as the battery stacks 12, the battery stacks 14 that are adjacent to each other in the up-down direction are fixed to each other via holes, which are formed in the end plates 15 respectively provided at each longitudinal end portion of the battery stacks 14, and through bolts 30.

In this manner, the plural battery stacks 14, which are stacked in the up-down direction, are referred to as a battery stack group (second battery stack group) 18. In the present exemplary embodiment, in the lower-layer battery stack group 26, plural battery stack groups 18 are arranged in a row (here, two rows) along the vehicle width direction. In other words, in the present exemplary embodiment, the lower-layer battery stack group 26 is configured by two battery stack groups 18.

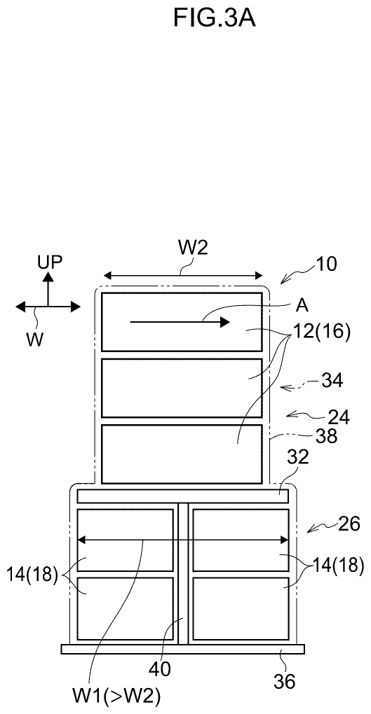

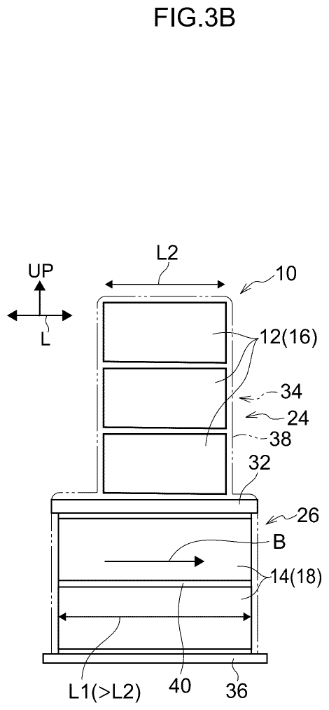

Here, as illustrated in FIG. 3A and FIG. 3B, in the present exemplary embodiment, the projection dimensions (W1 and L1) of the lower-layer battery stack group 26 are set to be larger than the projection dimensions (W2 and L2) of the upper-layer battery stack group 24. It should be noted that each of W1 and W2 is a width dimension along the vehicle width direction, and each of L1 and L2 is a length dimension along the vehicle front-rear direction.

Further, in the present exemplary embodiment, a plate-shaped frame member (first frame member) 32 is provided between the upper-layer battery stack group 24 and the lower-layer battery stack group 26, and the upper-layer battery stack group 24 and the lower-layer battery stack group 26 are fixed to the frame member 32, respectively.

In the present exemplary embodiment, the upper-layer battery stack group 24 and the lower-layer battery stack group 26 can be housed in a housing case 34. The housing case 34 includes a lower case 36 and an upper case 38. The lower case 36 is formed in a plate shape, the upper-layer battery stack group 24 and the lower-layer battery stack group 26 are covered from the outside by the upper case 38, and the frame member 32 is fixed to the upper case 38.

As an example, the upper case 38 may be securable to a cross member (vehicle skeleton) 35 that extends along the vehicle width direction at a vehicle rear side of the upper case 38, and the frame member 32 and the upper case 38 may be fastened to the cross member 35. It should be noted that the cross member 35 may be a rear cross member that configures part of a rear suspension member.

On the other hand, the lower-layer battery stack group 26 is fixed to the lower case 36. A plate-shaped frame member (second frame member) 40 is arranged between the battery stack groups 18 that configure the lower-layer battery stack group 26. The frame member 40 is upright with respect to the lower case 36 and is fixed in a state of extending along the vehicle front-rear direction, and a leading edge of the frame member 40 is joined to the frame member 32 via, for example, an adhesive, welding, or the like.

Next, explanation follows regarding operations and effects of the power storage device according to the present exemplary embodiment.

As illustrated in FIG. 1 and FIG. 2, in the present exemplary embodiment, the power storage device 10 includes the upper-layer battery stack group 24, the lower-layer battery stack group 26, and the frame member 32.

The upper-layer battery stack group 24 is configured by stacking battery stacks 12 (battery stack group 16) in the up-down direction, with the vehicle width direction (the direction of the arrow W) as the longitudinal direction of the upper-layer battery stack group 24. Further, the lower-layer battery stack group 26 is configured by arranging two rows of battery stack groups 18, in each of which the battery stacks 14 are stacked in the up-down direction, along the vehicle width direction, with the vehicle front-rear direction (the direction of the arrow L) as a longitudinal direction of the lower-layer battery stack group 26. In other words, in the present exemplary embodiment, the upper-layer battery stack group 24 and the lower-layer battery stack group 26 are arranged in the up-down direction in a state in which the longitudinal direction of the battery stacks 12 that configure the upper-layer battery stack group 24 and the longitudinal direction of the battery stacks 14 that configure the lower-layer battery stack group 26 are substantially orthogonal (intersected).

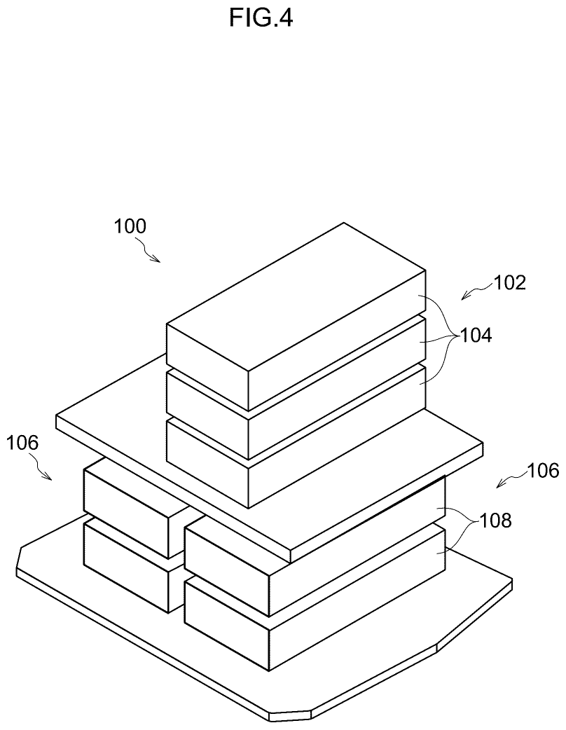

For example, as a comparative example, as illustrated in FIG. 4, in a power storage device 100, in a case in which battery stacks 108 of a lower-layer battery stack group 106 and battery stacks 104 of an upper-layer battery stack group 102 are stacked in the up-down direction with a longitudinal direction thereof being the same, vibration resistance becomes weak with respect to a width direction of the battery stacks 104 (a lateral direction that is orthogonal to the longitudinal direction). For this reason, in the comparative example, there are concerns regarding vibration resistance with respect to a vibration G in a specific direction. In this case, since a fixing portion of the lower-layer battery stack group 106 is subjected to stress, it is necessary to increase the fixing strength, such as by increasing the fixing points in the fixing portion.

In this regard, in the present exemplary embodiment, as described above, the longitudinal direction of the battery stacks 12 that configure the upper-layer battery stack group 24 and the longitudinal direction of the battery stacks 14 that configure the lower-layer battery stack group 26 are arranged in a substantially orthogonal state. As a result, in the present exemplary embodiment, it is possible to change the direction in which vibration resistance becomes weak between the upper-layer battery stack group 24 and the lower-layer battery stack group 26, and to achieve balance between the direction in which vibration resistance is strong and the direction in which vibration resistance is weak, whereby the direction in which vibration resistance is weak can be offset. As a result, in the present exemplary embodiment, vibration resistance of the power storage device 10 can be improved, and the influence of resonance can be suppressed.

Further, in general, in a case in which battery cells are stacked along a width direction that is orthogonal to a longitudinal direction of a battery stack, the longitudinal direction of the battery stack and the longitudinal direction of the battery cells become the same direction, and a substantially central portion of the battery stack in the longitudinal direction becomes easily bent.

In this regard, in the present exemplary embodiment, in the battery stacks 12, the battery cells 20 are stacked in the longitudinal direction of the battery stacks 12, and in the battery stacks 14, the battery cells 22 are stacked in the longitudinal direction of the battery stacks 14. For this reason, in the present exemplary embodiment, the longitudinal direction of the battery cells 20 differs from the longitudinal direction of the battery stacks 12, and the longitudinal direction of the battery cells 22 differs from the longitudinal direction of the battery stacks 14, whereby bending of a substantially central portion of the battery stacks 12 and the battery stacks 14 can be suppressed.

Further, for example, although not illustrated in the drawings, in battery stacks, in a so-called both-ends-fixed state in which both longitudinal ends are fixed, a longitudinal central portion may bend due to receiving repeated vibrations due to vehicle travel. In this case, it is conceivable to fix the battery stacks in the longitudinal direction central portion via a fastening member such as a bolt.

However, in the present exemplary embodiment, since the influence of resonance in the power storage device 10 can be suppressed in the first place, deformation itself of the battery stacks 12 and 14 can be suppressed. Therefore, in the longitudinal central portion of the battery stacks 12 and 14, a fastening member for suppressing deformation is unnecessary. In other words, in the present exemplary embodiment, it is possible to realize the power storage device 10 in which plural battery stacks 12 and 14 are stacked with the minimum necessary fastening members.

As a result, in the present exemplary embodiment, the number of components can be reduced as compared to the case in which the longitudinal direction central portion of the battery stacks 12 and 14 is fixed by a fastening member, and volumetric efficiency of the battery cells 20 and 22 can be improved by the elimination of the need to ensure a space for a fastening member.

Further, in the present exemplary embodiment, in the upper-layer battery stack group 24, the battery stack group 16 is arranged in the vehicle width direction, and in the lower-layer battery stack group 26, the battery stack group 18 is arranged in the vehicle front-rear direction. Furthermore, in the lower-layer battery stack group 26, plural battery stack groups 18 are arranged in a row along the vehicle width direction, and as illustrated in FIG. 3A and FIG. 3B, the projection dimensions (W1 and L1) of the lower-layer battery stack group 26 are set to be larger than the projection dimensions (W2 and L2) of the upper-layer battery stack group 24.

In this manner, in the present exemplary embodiment, since the arrangement space of the lower-layer battery stack group 26 is larger than arrangement space of the upper-layer battery stack group 24, the center of gravity of the power storage device 10 can be brought toward a lower-layer battery stack group 26 side, whereby the vibration stability of the power storage device 10 can be further improved.

Further, in the present exemplary embodiment, the housing case 34 that houses the upper-layer battery stack group 24 and the lower-layer battery stack group 26 is provided. A bottom wall portion of the housing case 34 is configured by the lower case 36, and the frame member 40 is fixed to the lower case 36. The frame member 40 is arranged between the adjacent battery stack groups 18 that configure the lower-layer battery stack group 26, and the respective battery stack groups 18 are fixed to the frame member 40.

In this manner, in the present exemplary embodiment, since plural battery stack groups 18 are respectively fixed to the frame member 40 that is fixed to the lower case 36, the vibration stability of the power storage device 10 can be further improved.

### Supplementary Features of the Present Embodiments

In the present exemplary embodiment, the power storage device 10 illustrated in FIG. 1 is arranged at the vehicle rear side, the upper case 38 of the power storage device 10 (see FIG. 3A) is fixed to the cross member 35 as the vehicle skeleton, and although the cross member 35 is described as a rear cross member of a rear suspension member, the vehicle skeleton is not limited thereto. For example, the vehicle skeleton may be a rear side member that extends in the vehicle front-rear direction, a rocker, or the like. In this case, both vehicle width direction end portions of the power storage device 10 are fixed. Further, the power storage device 10 is not limited to being arranged at the vehicle rear side, and may be arranged at a vehicle front side.

Further, in the present exemplary embodiment, although the upper case 38 is configured to cover the upper-layer battery stack group 24, the lower-layer battery stack group 26, and the frame member 32 from the outside, the present disclosure is not limited thereto. For example, the upper case 38 may be vertically divided by the frame member 32. Furthermore, the frame member 32 may configure a floor panel, the upper-layer battery stack group 24 may be provided at an upper side of the floor panel, and the lower-layer battery stack group 26 may be provided at a lower side of the floor panel.

Further, in the present exemplary embodiment, the upper-layer battery stack group 24 is configured by one battery stack group 16, and the battery stack group 16 is configured by three battery stacks 12 that are stacked in the up-down direction. Furthermore, the lower-layer battery stack group 26 is configured by two battery stack groups 18 arranged in the vehicle width direction, and each battery stack group 18 is configured by two battery stacks 14 that are stacked in the up-down direction.

However, in the present exemplary embodiment, since it is sufficient that the longitudinal direction of the battery stacks 12 and the longitudinal direction of the battery stacks 14 be arranged in a substantially orthogonal state, the number of the battery stacks 12 and the battery stacks 14 is not particularly limited. For example, the battery stack group 16 may be configured by two battery stacks 12 that are stacked in the up-down direction, and each battery stack group 18 may be configured by three battery stacks 14 that are stacked in the up-down direction.

Further, for example, in the upper-layer battery stack group 24, the battery stack group 16 may be arranged in the vehicle front-rear direction, and in the lower-layer battery stack group 26, each of the battery stack groups 18 may be arranged in the vehicle width direction. Furthermore, in the upper-layer battery stack group 24, plural battery stack groups 16 may be arranged in a row in the vehicle front-rear direction, and in the lower-layer battery stack group 26, three or more battery stack groups 18 may be arranged in a row in the vehicle width direction.

Although an exemplary embodiment of the present disclosure has been explained above, the present disclosure is not limited to such an embodiment, and obviously the exemplary embodiment and various modifications may be appropriately combined and used, and may be implemented in various forms within a range that does not depart from the gist of the present disclosure.

What is claimed is:

1. A power storage device, comprising:
a first battery stack group in which a plurality of first battery stacks, each having a substantially rectangular parallelepiped shape forming a substantially rectangular shape in plan view, are stacked in an up-down direction;
a second battery stack group in which a plurality of second battery stacks, each having a substantially rectangular parallelepiped shape forming a substantially rectangular shape in plan view, are stacked in the up-down direction, the second battery stack group being arranged at a lower side of the first battery stack group with a longitudinal direction of the second battery stack group being a direction that intersects with a longitudinal direction of the first battery stack group; and
a first frame member that is arranged between the first battery stack group and the second battery stack group, the first battery stack group and the second battery stack group being respectively fixed to the first frame member, and the first frame member being directly or indirectly fixed to a vehicle skeleton.

2. The power storage device according to claim 1, wherein:
in each of the plurality of first battery stacks, a plurality of first battery cells are stacked in a longitudinal direction of the plurality of first battery stacks; and
in each of the plurality of second battery stacks, a plurality of second battery cells are stacked in a longitudinal direction of the plurality of second battery stacks.

3. The power storage device according to claim 1, wherein:
an upper-layer battery stack group, which is configured by the first battery stack group, is arranged in a vehicle width direction;
a lower-layer battery stack group, which is configured by the second battery stack group, is arranged in the vehicle width direction; and
a plurality of second battery stack groups are arranged in a row such that a projection dimension of the lower-layer battery stack group is larger than a projection dimension of the upper-layer battery stack group.

4. The power storage device according to claim 3, further comprising:
a housing case that houses the upper-layer battery stack group and the lower-layer battery stack group;
a lower case that configures a bottom wall portion of the housing case; and
a second frame member that is fixed to the lower case and that is arranged between the plurality of second battery stack groups, with each of the plurality of second battery stack groups being fixed to the second frame member.
